(19) United States
(12) Patent Application Publication
(10) Pub. No.: US 2008/0226373 A1
(43) Pub. Date: Sep. 18, 2008

(54) Lettering tape, tape cassette, tape printer

(75) Inventors: Koshiro Yamaguchi, Kakamigahara-shi (JP); Tsutomu Kato, Nagoya-shi (JP)

Correspondence Address: DAY PITNEY LLP, 7 TIMES SQUARE, NEW YORK, NY, 10036-7311, US

(73) Assignee: BROTHER KOGYO KABUSHIKI KAISHI

(21) Appl. No.: 12/069,115

(22) Filed: Feb. 7, 2008

(30) Foreign Application Priority Data
Mar. 12, 2007 (JP) 2007-061375
Jun. 12, 2007 (JP) 2007-154946
Jun. 12, 2007 (JP) 2007-155199

(51) Int. Cl. B41J 31/09; B41M 5/40

(52) U.S. Cl. 400/237; 428/32.39

(57) ABSTRACT

A lettering tape is formed having an integrated layered configuration in which a base layer, an ink layer, and an adhesive layer exhibiting adhesive properties when heated are sequentially stacked. When the lettering tape is selectively heated by a thermal head to form an image thereon, the heated portion of the ink layer onto which an image has been formed is adhered to the heated portion of the adhesive layer and simultaneously, the heated portion of the adhesive layer exhibits self-adhesive properties, thereby enabling transfer to the target transfer body.

### CROSS-REFERENCE TO RELATED APPLICATIONS

This application is based upon and claims priorities from the prior Japanese Patent Applications No. 2007-061375 filed on Mar. 12, 2007, No. 2007-154946 filed on Jun. 12, 2007, and No. 2007-155199 filed on Jun. 12, 2007, the entire contents of which are incorporated herein by reference.

### BACKGROUND

1. Field

One or more aspects of disclosure relate to an instant lettering tape.

2. Description of Related Art

Generally, lettering is carried out by pressing a transfer image such as characters and graphic symbols and the like, formed onto a ready-made transfer sheet (including transfer material) on a receiving surface of a random transfer body and then peeling off the transfer sheet to transfer the image. The transfer sheet which allows for such an easy lettering operation is also known as instant lettering sheet. Various arts employing this type of transfer sheet have been conventionally proposed.

Apart from these, arts are also known in which an ink ribbon for producing a dry transfer material is used in a thermo-sensitive-type printer, type writer, word processor and the like and enables transfer and printing even to a surface with poor wettability and strong releasing property. With this ink ribbon, a transfer image obtained by thermal transfer to a transfer body (transfer sheet) is effectively retransferred onto a second transfer body which is the target of the transfer by applying pressure thereto.

Arts using a heat seal label which exhibits self-adhesive properties when heated include a technique that uses a belt-like heat seal label having a printing surface and an adhesive surface provided at the opposite side of the printing surface and having adhesive fixed thereon. According to these arts, after printing is performed onto a printing surface using an ink jet-type print method, the adhesive of the heat seal label is fused to an adhesive state and the ink printed onto the heat seal label is dried simultaneously.

According to the above-described background arts, any user can use existing devices such as a thermal transfer printer or the like and moreover, the above-described ink ribbon for producing a dry transfer material to produce a desired tape or sheet, of their choice, for use in instant lettering, which thus allows for a high degree of freedom. However, with this tape/sheet for instant lettering, the image formed on the ink layer of the ink ribbon is transferred to the first transfer body (transfer sheet), and then, the image of the ink layer, including a coloring agent, a binding agent and a adhesive is simply transferred to the target second transfer body, by applying pressure to the image by use of a transfer tool. Here, although the ink layer contains adhesive, basically, it does not have an adhesive layer, which means that it has weak adherence. When a user transfers an image of the ink layer in a first transfer body (transfer sheet) by applying pressure to this image using a transfer tool, or the like, the application of pressure differs depending on each user. Thus, depending on the user, the image of the ink layer in the first transfer body (transfer sheet) is not always entirely transferred, which results in a transfer having so-called transfer flecks where minute omissions occur partially. Also, since even the same user cannot possibly always apply the same pressure to the image of the ink layer in the first transfer body (transfer sheet), a problem occurs that a transfer fleck-free transfer cannot always be obtained.

Also, the technique of the above-described heat seal label does not include the concept of producing a tape or sheet for instant lettering.

Here, if the user can not identify the contents to be printed on the lettering tape before transferring the lettering tape, transfer of unexpected wrong lettering tape may be occurred. Also, if the contents to be printed are printed on the release sheet or the like, new process in which the contents to be printed is the release sheet is required.

Also, although the user can identify the contents to be printed on the lettering tape, if the user can not identify the color to be printed on the lettering tape before transferring the lettering tape, transfer of wrong lettering tape may be occurred.

Also, when a printing operation is conducted onto a lettering sheet having an adhesive layer, the adhesive may overflow the sheet end and the adhesive may be transferred (adhered) to a head or a platen. In addition, when conducting a printing operation using an ink ribbon, the ink of the ink ribbon may be adhered to a head or a platen.

### SUMMARY

One of more aspects of the disclosure has been made in view of the above circumstances and has an object to overcome the above problems by providing an instant lettering tape that has a tape which is formed by sequentially stacking a base layer, an ink layer and a adhesive layer that exhibits self-adhesive properties when heated once, wherein a dedicated adhesive layer is exposed at a surface thereof at the time of transfer. The tape is heated to form an image on the ink layer and is stuck to the target transfer body after the adhesive layer becomes sticky. Then, the tape is removed. This self-adhesive property exhibited by the adhesive layer when heated enables any user to perform transfer fleck-free transfer at any time.

Also, one or more aspects of the disclosure has an object to provide instant lettering tape in which the user can identify the contents and/or the color to be printed on the lettering tape before transferring the lettering tape.

Also, one or more aspects of the disclosure have an object provide an instant lettering tape capable of preventing the adhesive of a lettering tape or the ink of an ink ribbon from adhering to a thermal head or a platen can be prevented.

To achieve the above object, according to a first aspect of the disclosure, there is provided a lettering tape comprising: a base layer; an ink layer; an adhesive layer exhibiting self-adhesive properties when heated; wherein the base layer, the ink layer, and the adhesive layer are sequentially stacked, when the lettering tape is selectively heated by a heat generating body a heated portion of the ink layer is adhered to a heated portion of the adhesive layer, the heated portion of the ink layer and the heated portion of the adhesive layer are transferred to a target transfer body when the heated lettering tape is stuck to the target transfer body and then the lettering tape is removed.

In the above lettering tape, there is provided a lettering tape having an integrated layered configuration in which a base layer, an ink layer and a adhesive layer exhibiting self-adhesive properties when heated once are sequentially stacked, so that when this lettering tape is selectively heated by a heat generating body to form an image thereon, a heated portion of the ink layer onto which the image is formed is adhered to the heated portion of the adhesive layer, and simultaneously, the heated portion of the adhesive layer exhibits self-adhesive properties, thereby converting the lettering tape itself into a lettering tape enabling transfer to the target transfer body.

Accordingly, a desired lettering tape can be obtained by simply heating this lettering tape directly by means of the heat generating body. Thus, since it is no longer necessary to transfer the image formed by the ink layer of a different ink ribbon to the transfer sheet and then perform a second stage transfer of transferring the image to the target transfer body, as was done conventionally, handling of the lettering tape becomes easy. Also, since the second stage transfer is no longer required, the transfer quality can be improved.

According to a second aspect of the disclosure, there is also provided a tape cassette, wherein the roll tape according to claim 3 is installed.

In the above tape cassette, the tape cassette houses the roll of the lettering tape in a cassette case.

Accordingly, the tape cassette can be set to a print enable state by a simple operation of mounting the tape cassette in the cassette mounting part of the printer. Also, loading the roll of the lettering tape in the tape cassette in advance for provision to users can prevent incorrect setting of the lettering tape in the printer by the user that may mistake the front and back surface of the tape.

According to a third aspect of the disclosure, there is also provided a tape printer comprising: a cassette mounting part; a thermal head; and a platen roller; wherein a tape cassette including a lettering tape is detachable for the cassette mounting part, the lettering tape including a base layer, an ink layer, and an adhesive layer exhibiting self-adhesive properties when heated, the base layer, the ink layer, and the adhesive layer being sequentially stacked, a side of the base layer in the lettering tape abuts on the thermal head when the tape cassette is mounted in the tape printer, when the lettering tape is selectively heated by the thermal head, a heated portion of the ink layer is adhered to a heated portion of the adhesive layer.

In the above tape printer, a tape cassette including a lettering tape is detachable. Here, the lettering tape includes a base layer, an ink layer, and an adhesive layer exhibiting self-adhesive properties when heated, the base layer, the ink layer, and the adhesive layer being sequentially stacked. Also, a side of the base layer in the lettering tape abuts on the thermal head when the tape cassette is mounted in the tape printer. When the lettering tape is selectively heated by the thermal head, a heated portion of the ink layer is adhered to a heated portion of the adhesive layer.

Accordingly, a desired lettering tape can be obtained by simply heating this lettering tape directly by means of the heat generating body. Thus, since it is no longer necessary to transfer the image formed by the ink layer of a different ink ribbon to the transfer sheet and then perform a second stage transfer of transferring the image to the target transfer body, as was done conventionally, handling of the lettering tape becomes easy. Also, since the second stage transfer is no longer required, the transfer quality can be improved.

### BRIEF DESCRIPTION OF THE DRAWINGS

The accompanying drawings, which are incorporated in and constitute a part of this specification illustrate embodiments of the disclosure and, together with the description, serve to explain the objects, advantages and principles of the disclosure.

FIG. 1 is a top view showing an outside appearance of a printer according to the present embodiment.

FIG. 2 is a bottom view of the printer with a main body lower cover removed therefrom, for describing a cassette mounting part in which a tape cassette is to be mounted.

FIG. 3 is a perspective view of a printer for describing mounting the tape cassette in the cassette mounting part of the printer.

FIG. 4 is an explanatory view for describing a state of the printer in which the tape cassette is mounted in a print unit composed of a thermal head and a platen, and a cassette upper cover of the tape cassette is removed.

FIG. 5 is a block diagram showing a control configuration of the printer.

FIG. 6 is an explanatory diagram showing a process of producing a transferable lettering tape in the printer and then transferring it to a transfer body.

FIG. 7 is an explanatory diagram for describing a process of forming, in the printer, a transferable lettering tape having a thermo-sensitive color-fixing agent coated on a surface of a base layer thereof and then transferring the tape to the transfer body.

FIG. 8 is a lateral section view showing positional relationships of a lettering tape, the thermal head, and the platen roller.

FIG. 9 is a lateral section view showing positional relationships of the lettering tape, the thermal head, and the platen roller.

FIG. 10 shows a range coated with the adhesive.

FIG. 11 a lateral section view showing positional relationships of the lettering tape, the thermal head, and the platen roller.

FIG. 12 a lateral section view showing positional relationships of the lettering tape, the thermal head, and the platen roller.

### DETAILED DESCRIPTION

The various aspects summarized previously may be embodied in various forms. The following description shows by way of illustration of various combinations and configurations in which the aspects may be practiced. It is understood that the described aspects and/or embodiments are merely examples, and that other aspects and/or embodiments may be utilized and structural and functional modifications may be made, without departing from the scope of the present disclosure.

It is noted that various connections are set forth between items in the following description. It is noted that these connections in general and, unless specified otherwise, may be direct or indirect and that this specification is not intended to be limiting in this respect.

A detailed description of an exemplary embodiment of a lettering tape and a printer according to the disclosure will now be given referring to the accompanying drawings.

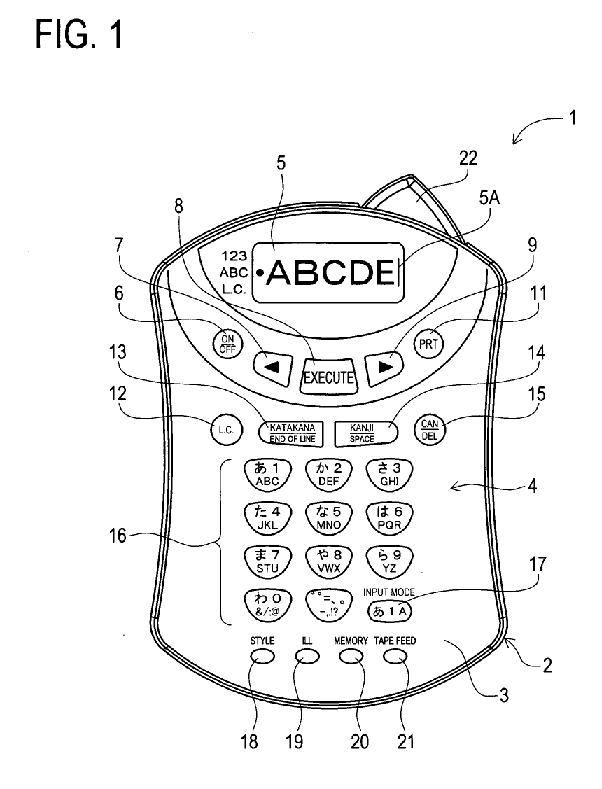

First, a schematic configuration of the lettering tape and the printer according to the present embodiment will next be described based on FIG. 1 through FIG. 5.

As shown in FIG. 1, the printer 1 of the present embodiment comprises a keyboard 4 arranged in a body upper case 3 of a body 2. Then, a liquid crystal display 5 (hereinafter referred to as LCD) is provided at an upper side of the keyboard. The LCD 5 is adapted to display characters, symbols and the like inputted from the keyboard 4.

A top row of the above-mentioned keyboard 4 includes, from left to right, a power ON/OFF key 6 that turns the power ON and OFF, a left arrow key 7 that moves a cursor 5A displayed on the LCD 5 and selects a candidate at the time of kanji conversion and at the time of function selection, an execute 8 key that decides a character from the characters in the negative display and the flashing display on the LCD 5, and decides a choice at the time of kanji conversion and at the time of function 5 setting, a right arrow key 9 that moves the cursor 5A displayed on the LCD 5 and selects a candidate at the time of kanji conversion and at the time of function setting, and a print key 11 that prints the inputted text onto a lettering tape 10 to be described later.

In the following row, the keyboard 4 comprises, from left to right, a lowercase letter key 12 that switches letters to lowercase input, a katakana conversion/end-of-line key that converts kana characters, should there be any, in a negative display and flashing display on the LCD 5 into katakana, and inserts line feeds if there are no negative displays and flashing displays, a kanji conversion/space key 14 that converts kana characters in a negative display and flashing display on the LCD 5 into kanji, and inputs a space if no characters are present in the negative display and the flashing display or if alphabetical and numerical characters are input, and a cancel/delete key 15 that deletes a character at the left side of the cursor 5A displayed on the LCD 5 and cancels the set operation at the time of function setting to return to the input screen.

In the following rows, the keyboard contains character key group 16 for inputting kana, kanji, alphabetical characters and symbols. Each one key in the character key group 16 is allocated a plurality of characters. Character candidates are switched in a rotary input scheme by successively pressing the same key. At a bottom right corner of the character key group 15, there is provided an input switching key 17 that switches the input mode of the characters to kana, numerical characters and alphabetical characters in a rotary input type.

At the lower side of the character key group 16, the keyboard 4 comprises, from left to right, a style key 18 that sets the font type, character size, character decoration, decoration frame, blank spaces of the lettering tape 10, an illustration key 19 that calls an illustration menu when a symbol or a pictogram is inputted, a memory key 20 that records the text in the memory and calls the text from the memory, and a tape feed key 21 that preliminary feeds the lettering tape 10 of a predetermined length.

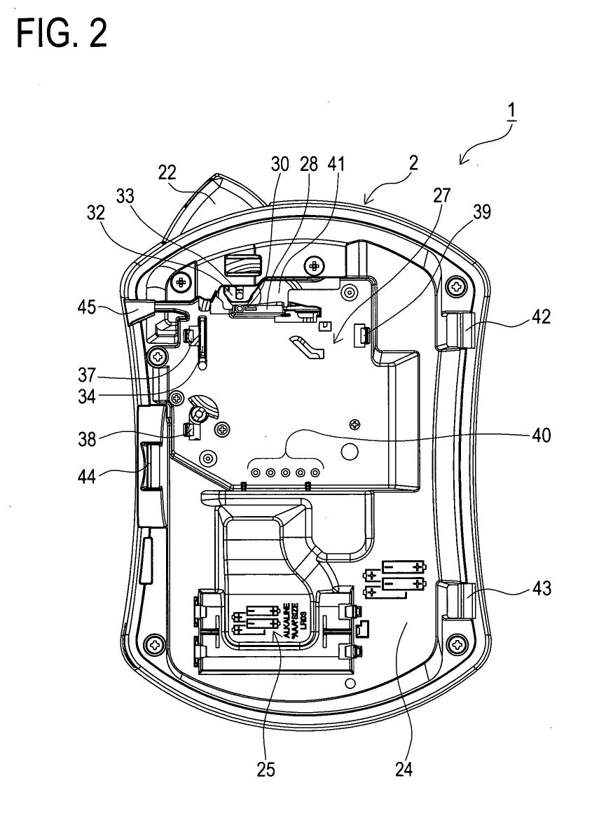

A tape cutter level lever 22 is provided in an upper side wall of body 2 (upper side in FIG. 2) to cut the printed lettering tape 10.

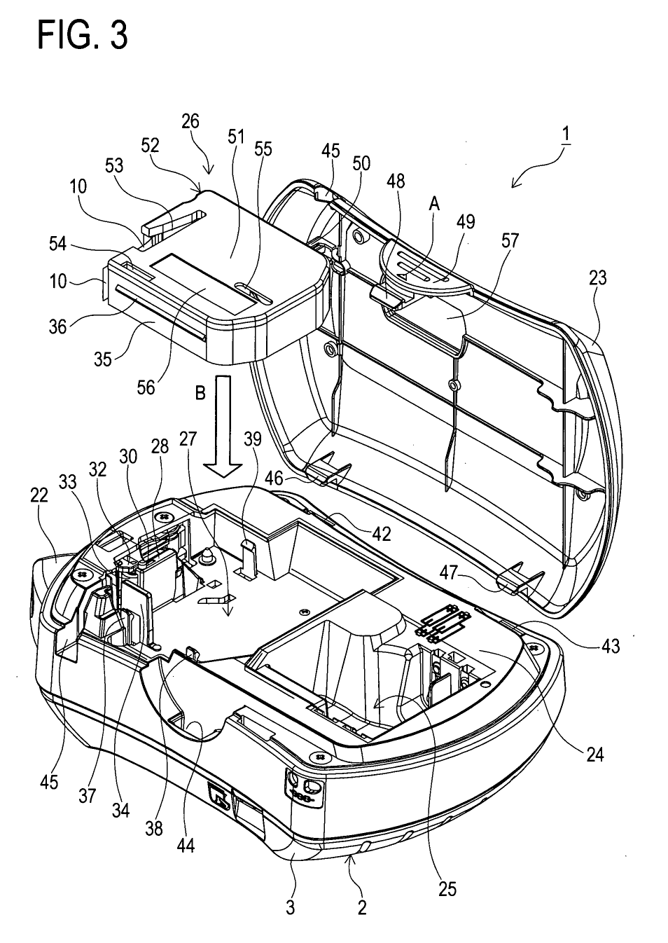

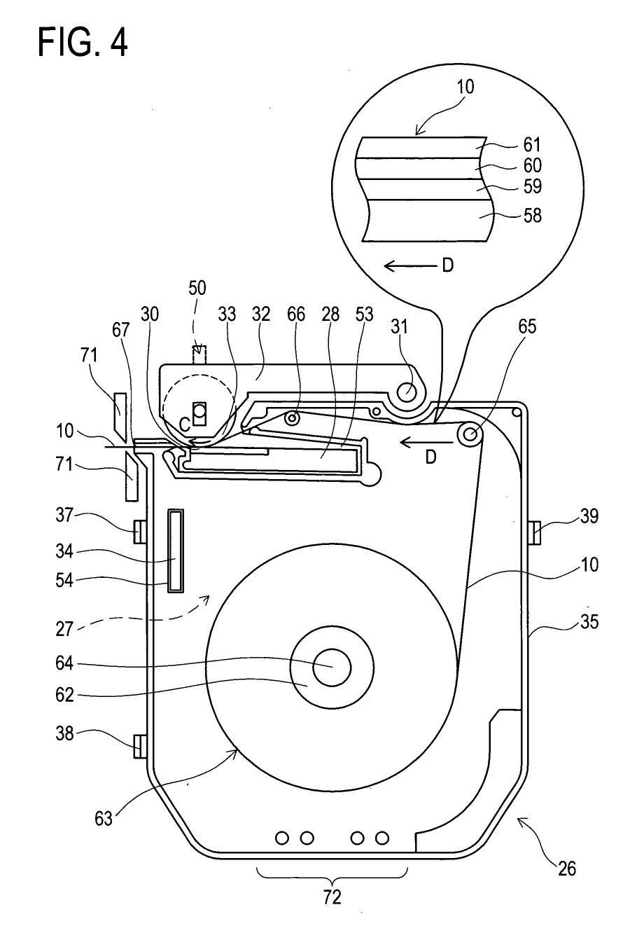

Next, as shown in FIG. 2, two recessed portions are formed in the body lower case 24 having the body lower cover 23 removed therefrom (refer to FIG. 3). One of these recessed portions (lower side in FIG. 2) has a battery mounting part 25 in which a plurality of batteries are mounted to supply power to the printer 1. The other recessed portion (upper side in FIG. 2) has a cassette mounting part 27 in which the tape cassette 26 (refer to FIG. 3 and FIG. 4) to be described later is detachably mounted.

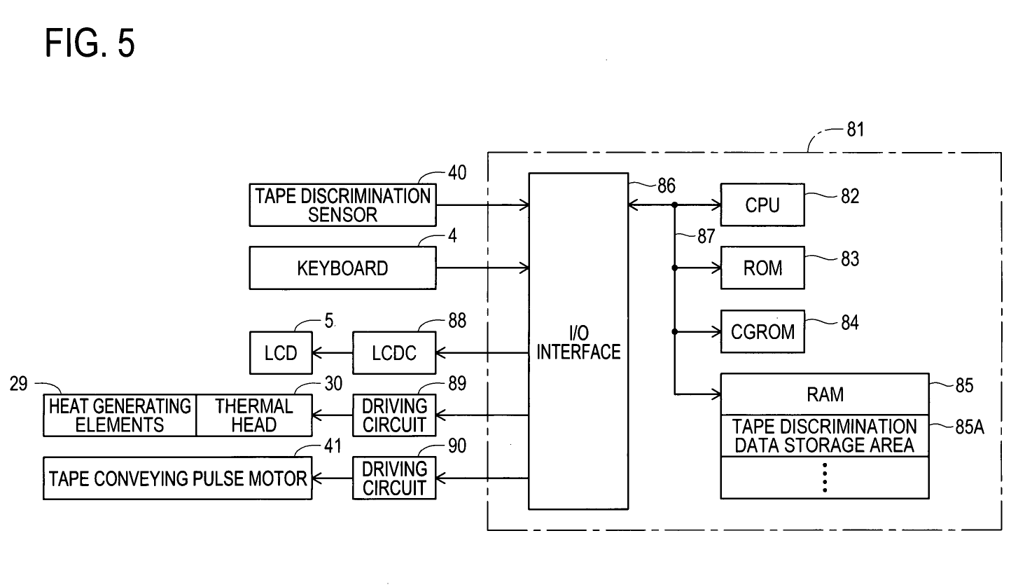

At an upper side of the cassette mounting part 27 is mounted a thermal head 30 that has a plurality of heat generating elements 29 (refer to FIG. 5) arranged in a heat radiation plate 28 provided on an un-illustrated frame in an upright position. At a position facing the thermal head 30, a platen roller 33 is rotatably mounted in a roller holder 32 which is in turn rotatably mounted with respect to a rotary shaft 31 (refer to FIG. 4) provided in an un-illustrated frame in an upright position. The platen roller 33 is generally formed of a material including synthetic rubber such as silicone, EPDM or the like, in consideration of the heat resistance property, weather resistance property, prevention of adhesion of the adhesive and the like. Nevertheless, the selection range of the material for the platen roller can be extended by insulating the platen roller 33 with respect to the adhesive by a release sheet 61 to be described later.

At a left side upper portion of the cassette mounting part 27, a cassette positioning rib 34 is provided on an un-illustrated frame in an upright position. This cassette positioning rib 34 has the role of positioning the tape cassette 26 (refer to FIG. 3) at the time of its mounting in the cassette mounting part 27.

Also, at a left side of the cassette positioning rib 34, a cassette locking claw 37 is provided on the body lower case 24 in an upright position to thus fix the tape cassette 26 in the cassette mounting part 27 at the time of its mounting in the cassette mounting part 27. This cassette locking claw 37 is locked and fixed in a locking groove 36 (refer to FIG. 3) formed in a side wall of the cassette lower case 35 (refer to FIG. 3) of the tape cassette 26. At the same time, a cassette locking claw 38 is provided on the body lower case 24 in an upright position at a predetermined distance from the lower side of the cassette locking claw 37. At a right side end portion of the cassette mounting part 27 facing the cassette locking claw 37, a cassette locking claw 39 is provided on the body lower case 24 in an upright position to fix the tape cassette 26 in the cassette mounting part 27 at the time of its mounting in the cassette mounting part 27. This cassette locking claw 93 is locked and fixed in an un-illustrated locking groove formed in the side wall of the cassette lower case 35 (refer to FIG. 3) of the tape cassette 26.

At a lower side of the cassette mounting part 27 is provided a tape discrimination sensor 40 for discriminating the type of the tape cassette 26. The tape discrimination sensor 40 is composed of a plurality of mechanical switches, such as micro switches and the like and is set so that the switches are turned on when pressed. When the tape cassette 26 is not mounted in the cassette mounting part 27, all mechanical switches are turned off.

A tape conveying pulse motor 41 is provided at a lower side in a perpendicular direction with respect to the plan of the platen roller 33. When the platen roller 33 and the thermal head 30 are brought into contact, the tape conveying pulse motor 41 is coupled with the platen roller 33 through an intermediate gear not shown, and the platen roller 33 is rotated by the rotation of the tape conveying pulse motor 41.

A cover locking hole 42 is provided at an upper side and a cover locking hole 43 is provided at a lower side of a right side end portion of the body lower case 24, and a cover lock hole 44 is provided in the center of the right side end portion for mounting a body lower cover 23 in the body lower case 24. A discharge port 45 for discharging the lettering tape 10 is provided in the side wall of the body 2 on a left extended line of the heat radiation plate 28 onto which the thermal head 30 is mounted.

FIG. 3 shows a state that the body lower cover 23 is removed from the body lower case 24 and the tape cassette 26 is to be mounted in the cassette mounting part 27. A cover locking claw 46, a cover locking claw 47 and a cover lock claw 48 are provided in a body lower cover 23 at a position facing the cover locking hole 42, the cover locking hole 43 and the cover lock hole 44 provided in the body lower case 24. When the body lower cover 23 is mounted in the body lower case 24, the cover locking claw 46 is locked into the cover locking hole 42 and the cover locking claw 47 is locked into the cover locking hole 43, whereby the cover lock claw 48 is locked into the cover lock hole 44. If the body lower cover 23 is removed from the body lower case 24, the lock release button 49 formed to be integral with the cover lock claw 48 is rotated while applying pressure thereon in the direction of the arrow A, with the cover locking claw 46 and the cover locking claw 47 as a support, to thus release the lock of the cover lock hole 44 and the cover lock claw 48. When the body lower cover 23 is lifted while the lock release button 49 is rotated, the lock of the cover locking claw 46 and cover locking claw 47 with the cover locking hole 42 and the cover locking hole 43 is released, thereby allowing removal of the body lower cover 23 from the body lower case 24.

Since the platen roller 33 mounted in the roller holder 32 is pressed against the thermal head 30 when the body lower cover 23 is removed, the roller holder 32 is released from the pressing force of the roller holder pressing rib 50 provided in an upright position on the body lower cover 23 that is pressed against the roller holder 32, whereby the roller holder 32 is moved away from the thermal head 30 by an elastic member not shown. The platen roller 33 mounted in the roller holder 32 as well is then moved away from the thermal head 30 whereby a space is formed between the platen roller 33 and the thermal head 30. Thus, when the tape cassette 26 is mounted into the cassette mounting part 27, the lettering tape 10 can be securely set between the platen roller 33 and the thermal head 30.

As shown in FIG. 3, the tape cassette 26 has a configuration in which a lettering tape 10 is loaded in a cassette case 52 formed of a cassette lower case 35 and a cassette upper cover 51. When the tape cassette 26 is mounted in the cassette mounting part 27, an opening portion 53 and a cassette positioning hole 54 are provided in the cassette case 52. The opening portion 53 houses the thermal head 30 provided in the cassette mounting part 27 and the cassette positioning hole 54 houses the cassette positioning rib 34 provided in the cassette mounting part 27. Further, on the cassette upper cover 51 is provided a residual tape confirmation hole 55 through which the remaining amount of the lettering tape 10 can be confirmed. Also, on the cassette upper cover 51 is applied a label 56 specifying the type of the tape cassette 26. The body lower cover 23 is provided with a confirmation window 57 which allows confirming the presence or absence of the tape cassette 26, the type of the tape cassette 26 and the residual amount of the lettering tape 10 even when the body lower cover 23 is mounted on the body lower case 24.

Upon mounting the tape cassette 26 in the cassette mounting part 27, the tape cassette 26 is mounted in the cassette mounting part 27 in the direction of the arrow B. First, the cassette positioning hole 54 of the tape cassette 26 is aligned with the cassette positioning rib 34 of the cassette mounting part 27, and the opening portion 53 of the tape cassette 26 is aligned with the heat radiation plate 28 including the thermal head 30 of the cassette mounting part 27, after which the tape cassette 26 is pressed in the direction of arrow B. The tape cassette 26 is pressed until a click sound is heard when the cassette locking claw 37 and the cassette locking claw 38 are locked into the locking groove 36 provided in the side wall of the cassette lower case 35 of the tape cassette 26, and the cassette locking claw 39 is locked into an un-illustrated locking groove which is provided in the side wall of the cassette lower case 35 of the tape cassette 26. The click sound means that the tape cassette 26 is mounted and fixed in the cassette mounting part 27 by the cassette locking claw 37, the cassette locking claw 38 and the cassette locking claw 39. Then, when the body lower cover 23 is removed from the body lower case 24 as described in the above text, a space is formed between the platen roller 33 and the thermal head 30, so that when the tape cassette 26 is mounted in the cassette mounting part 27, the lettering tape 10 is securely set between the platen roller 33 and the thermal head 30.

The cover locking claw 46 and the cover locking claw 47 of the body lower cover 23 are inserted in the cover locking hole 42 and the cover locking hole 43 of the body lower case 24, and simultaneously, the body lower cover 23 is rotated with respect to the body lower case 24 having the tape cassette 26 mounted in the cassette mounting part 27, with the cover locking claw 46 and the cover locking claw 47 as a support. The cover lock claw 48 of the body lower cover 23 is inserted and locked in the cover lock hole 44 of the body lower case 24, thereby mounting the body lower cover 23 in the body lower case 24.

At this time, the roller holder 32 is pressed to the thermal head 30 side by the roller holder pressing rib 50 provided in the body lower cover 23, so that the platen roller 33 provided in the roller holder 32 depresses the thermal head 30 through the lettering tape 10. A flexible member which is not shown is also provided in the platen roller 33 to press the platen roller 33 to the thermal head 30 side. As a result, an excess or shortage of pressing force at the time the roller holder pressing rib 50 presses the roller holder 32 is thus adjusted, thereby always enabling appropriate printing.

With this, the printer 1 is fully prepared for printing on the lettering tape 10.

An internal configuration of the tape cassette 26 and a configuration of the lettering tape 10 will be described with reference to FIG. 4.

The state of the tape cassette 26 shown in FIG. 4 will be described. As described in the above text, when the body lower cover 23 is removed from the body lower case 24, the roller holder 32 is released from the pressing force of the roller holder pressing rib 50 provided on the body lower cover 23 in an upright position, so that the roller holder 32 is rotated around the rotary shaft provided in an upright position on a frame which is not shown so as to be moved away from the thermal head 30 by the flexible member which is not shown. Simultaneously, the platen roller 33 mounted in the roller holder 32 is moved away from the thermal head 30, whereby a space is formed between the platen roller 33 and the thermal head 30. Here, the tape cassette 26 is pressed in this space through the lettering tape 10, while aligning the cassette positioning hole 54 of the tape cassette 26 with the cassette positioning rib 34 of the cassette mounting part 27, and simultaneously aligning the opening portion 53 of the tape cassette 26 with the heat radiation plate 28 including the thermal head 30 in the cover mounting part 27, thereby mounting the tape cassette 26 in the cassette locking claw 37, cassette locking claw 38 and cassette locking claw 39 of the cassette mounting part 27. After that, the roller holder 32 is pressed again by the roller holder pressing rib 50 provided in an upright position on the body lower cover 23 when mounting the body lower cover 23 in the body lower case 24, so that the platen roller 33 presses the thermal head 30 through the lettering tape 10. FIG. 4 shows this state, with the cassette upper cover 51 removed from the tape cassette 26.

Next, a description will be given of an enlarged view of the lettering tape 10 shown in FIG. 4. The lettering tape 10 is configured to comprise a base layer 58 that is formed of a polyester, polycarbonate or a polyphenylene sulfide film or the like having an allowable temperature limit of 150° C. or above; an ink layer 59 provided on the base layer 58 and including a coloring agent, binder agent and the like; a adhesive layer 60 provided on this ink layer 59 and exhibiting self-adhesive properties when heated once and maintaining these self-adhesive properties after its temperature drops; and a release sheet 61 provided on the adhesive layer 60 and adapted to prevent adherence of the lettering tape 10 to locations other than the target locations when the adhesive layer 60 exhibits self-adhesive properties.

Then, the lettering tape 10 having the above-described configuration is wound in a roll 63 as a roll tape, with the release sheet 61 at the outer side of a tape spool 62, and the tape spool 62 is rotatably inserted into a cassette boss 64 provided in an upright position on the bottom surface of the cassette lower case 35, whereby the roll 63 is loaded in the cassette lower case 35. Further, an end of the lettering tape 10 protrudes to the outside from a tape discharging part 67 of the tape cassette 26, after passing between the thermal head 30 and the platen roller 33, via a guide boss 65 and a guide boss 66 provided in an upright position on the bottom surface of the cassette lower case 35. The lettering tape 10 is routed to make the base layer 58 constituting the lettering tape 10 come into contact with the thermal head 30. Winding the lettering tape 10 into a roll tape helps prevent bending, folding and scratching of the lettering tape 10 at the time of handling. Further, winding the lettering tape 10 to be set into a roll tape-shaped roller 63 even in the case the lettering tape 10 is loaded in the cassette tape 52, makes it possible to minimize the surface of the lettering tape 10 to be set and makes mounting of the lettering tape 10 in the cassette case 52 easy. Then, as a result of loading the roll 63 of lettering tape 10 in the cassette case 52 and then, in the tape cassette 26, the lettering tape 10 can be set to a print-enable state and incorrect setting of the lettering tape 10 in the printer 1 by the user that may mistake the front and back surface of the tape can be prevented by a simple operation of mounting the tape cassette 26 in the cassette mounting part 27 of the printer 1.

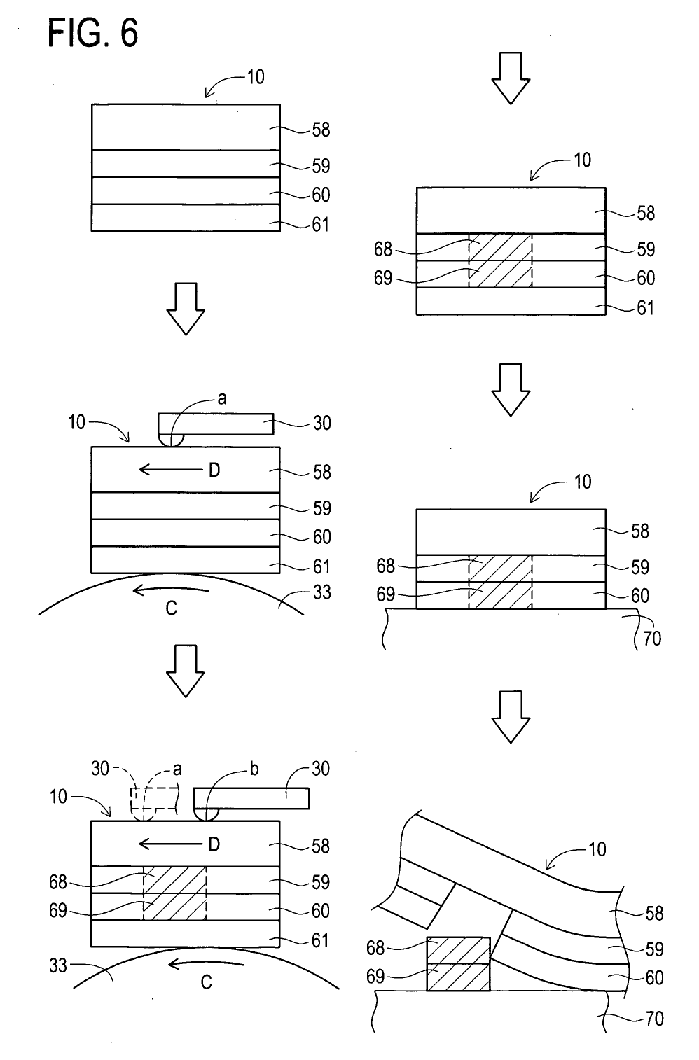

As described in the above text, when the roller holder pressing rib 50 presses the roller holder 32 and the platen roller 33 presses the thermal head 30 through the lettering tape 10, the platen roller 33 and the tape conveying pulse motor 41 are coupled by a gear that is not shown. In an operating state of the printer 1 obtained by pressing the power ON/OFF key 6 of keyboard 4, if the tape feed key 21 is pressed, the platen roller is rotated in the direction of arrow C by the rotation of the tape conveying pulse motor 41, whereby the lettering tape 10 is conveyed in the direction of arrow D and protrudes outside from the discharge port 45 of the body 2 after passing through the tape discharging part 67. Since the platen roller 33 is rotated in the direction of arrow C by the rotation of the tape conveying pulse motor 41, the lettering tape 10 is conveyed in the direction of arrow D even in the case there is data inputted by the keyboard 4 and the print key 11 has been pressed. Then, the thermal head 30 selectively heats the lettering tape 10 based on the data inputted through the keyboard 4, whereby a heated portion 68 of the ink layer 59 (refer to FIG. 6) is adhered to the heated portion 69 (refer to FIG. 6) exhibiting self-adhesive properties when the adhesive layer 60 is heated. In this state, the lettering tape 10 itself that could not be transferred to the transfer body 70 (refer to FIG. 6) as is, is converted into the lettering tape 10 that can be transferred to the transfer body 70 when selectively heated by the thermal head 30.

After the tape is fed or printed as described in the above text, the lettering tape 10 conveyed in the direction of arrow D and protruding outside from the discharge port 45 of the body 2, after passing through the tape discharging part 67 is cut by cutters 71 and 71 provided downstream the tape discharging part 67 of the tape cassette 26. These cutters 71 and 71 are operated by a tape cutter level 22 (refer to FIG. 1 and FIG. 3) provided in the upper side surface of the body 2 and a mechanism that is not shown. The post-printing lettering tape 10 to be cut by the cutters 71 and 71 provided downstream of the tape discharging part 67 in the tape cassette 26 does not need to be cut by scissors or the like, and the length of the lettering tape from the print position can be reduced at least one end, thereby allowing easy positioning at the time of transferring the lettering tape produced by this printer 1 to the target transfer body 70.

As shown in FIG. 4, tape type discrimination holes 72 showing the type of the tape cassette 26 are provided in a lower end side of the cassette lower case 35 at a position facing the tape discrimination sensor 40 provided in the cassette mounting part 27 (refer to FIG. 2). The mechanical switches at locations where no tape type discrimination holes 72 are provided are turned on when pressed from the bottom surface of the cassette lower case 35. Also, the mechanical switches of the tape discrimination sensor 40 at locations where the holes are provided are turned OFF when not pressed. Depending on this combination, the tape discrimination sensor 40 identifies the type of the tape cassette 26. The type of the tape cassette 26 is determined based on the combination of the color of the ink layer 59, the width of the lettering tape 10, the length of the lettering tape 10 and the like. Since the thickness of the cassette case 52 includes the thickness of the cassette lower case 35 which is decided by the cassette locking claws 37, 38 and 39, the thickness of the cassette case 52 is adjusted by changing the thickness of the cassette lower cover 51 in accordance the width of the lettering tape 10. The width of the platen roller 33 is set to be equal to or slightly larger than the maximum width of the lettering tape 10 which is assumed will be used. Also, the number of heat generating bodies and the resolution at which the thermal head 30 can print onto a maximum width lettering tape 10 which is assumed will be used are also set.

A control system of the printer 1 having the above-described configuration will be described while referring to FIG. 5. As shown in FIG. 5, the printer 1 is configured around a control part 81. The control unit 81 is composed of a CPU 82, a ROM 83, a CGROM 84, a RAM 85 and an I/O interface 86. All these are connected to each other through a bus line 87.

The ROM 83 is adapted to store different types of programs, and stores different types of programs, such as print control programs and the like required to control the printer 1. The CPU 82 carries out different types of operations based on the different programs stored in the ROM 83. The ROM 83 stores, with respect to a multitude of characters such as letters and the like, outline data that specifies the outline of each character, the outline data being sorted into different font types (Gothic-style font type, Ming-style font type or the like) and associated with code data.

The CGROM 84 stores dot pattern data corresponding to the respective characters to be inputted from the character key group 16. The dot pattern data is read out from the CGROM 84 and a dot pattern is displayed on the LCD 5 based on this dot pattern data. The RAM 85 is adapted to temporarily store the results of the different operations carried out by the CPU 82. When the type of the respective tape cassette 26 mounted in the body 2 is discriminated from the data read out by the data discrimination sensor 40, a tape discrimination data storage area 85A in which a tape discrimination data table which is the base of the discrimination and is not shown here is stored, is set in the RAM 85. Further, the RAM 85 is provided with different types of memory including a text memory for storing an inputted text, an image buffer for storing an image to be displayed on the LCD 5, a print buffer that stores an image to be printed, and a backup memory for storing a created text for later re-use, while the print device 1 is OFF.

To the I/O interface 86 are connected a tape discrimination sensor 40 and a keyboard 4 including a character key group 16, a power ON/OFF key 6, a print key 11, a tape feed key 21 and the like provided in body 2. If a display controller (LCDC) 88 that drives and controls the LCD 5 is connected to the I/O interface 86 so that when characters and the like are inputted through the character key group 16, the text data is sequentially stored into the text memory and simultaneously, a dot pattern corresponding to the characters and the like inputted through the character key group 16 based on the dot pattern generation control program and the display control program is displayed on the LCD 5. When a print instruction is given through the print key 11, dot pattern data is formed as a print image in the print buffer, based on the text data (text) stored in the text memory. Then, the dot pattern data of the print buffer is printed onto the lettering tape 10 through the cooperation of the driving circuit 89 that drives and controls the thermal head 30 with the platen roller 33. A driving circuit 90 that drives and controls the tape conveying pulse motor 41 is also connected to the I/O interface 83, so that the lettering tape 10 printed in cooperation with the platen roller 33 is discharged to the outside from a discharge port 45 of the body 2, after passing through the tape discharging part 67.

A process of producing a transferable lettering tape 10 and transferring the tape to the target transfer body 70 using the lettering tape 10 and the printer 1 having the above-described configuration will be described based on FIG. 6.

FIG. 6 shows, at a left upper stage, a state in which a lettering tape 10 at an upstream side above the location where the lettering tape 10 is clamped between the thermal head 30 and the platen roller 33 at an inner side of the tape cassette 26. As described in the above text, the lettering tape 10 has a layered configuration in which a base layer 58, an ink layer 59, an adhesive layer 60 and a release paper 61 are sequentially stacked. Since the adhesive layer 60 contains an adhesive that exhibits self-adhesive properties when heated once and maintains its self-adhesive properties after a drop in temperature as well, the adhesive layer does not exhibit self-adhesive properties if not heated. This helps prevent the adverse effects caused by accidental adherence of the lettering tape 10 to various places, and helps make handling thereof easier. Also, this prevents overflow of the adhesive, adherence of the roller 63 to the cassette case 52 and adherence of foreign bodies thereto, even after the lettering tape 10 is wound in roller 63 to be mounted in the cassette case 52.

At a left middle stage of FIG. 6 is shown the state in which when the lettering tape 10 is clamped between the thermal head 30 and the platen roller 33 at an inner side of the tape cassette 26 and text data (text) is inputted from the keyboard 4, after which the print key 11 is pressed, the tape conveying pulse motor 41 is rotated to rotate the platen roller 33 in the direction of arrow C. Simultaneously, the lettering tape 10 is conveyed in the direction of arrow D to initiate printing from point a where the thermal head 30 presses the lettering tape 10. The base layer 58 of the lettering tape 10 abuts on the thermal head 30 and the release sheet 61 abuts on the platen roller 33. By bringing the base layer 58 of the lettering tape 10 into contact with the thermal head 30, the ink layer 59 and the adhesive layer 60 are selectively heated without the danger of the adhesive exhibiting self-adhesive properties adhering to the thermal head 30. Also, by using a polyester film or the like with high heat resistance properties, slippage of the tape with respect to the thermal head 30 is improved, thereby reducing the load to the tape conveying pulse motor 41. The release sheet 61 provided on the surface of the lettering tape 10 is brought into contact with the platen roller 33, to thus prevent the lettering tape 10 from adhering to and being caught in the platen roller 33 provided in printer 1 and having a tape feed function, when the thermal head 30 selectively heats the adhesive layer 60 to thereby make it exhibit self-adhesive properties.

Next, at a left lower stage of FIG. 6 is shown a state in which the tape conveying pulse motor 41 is rotated to further rotate the platen roller 33 in the direction of arrow C, and simultaneously convey the lettering tape 10 as well in the direction of arrow D, from the state shown in the left middle stage of FIG. 6. Here, printing is initiated from point a where the thermal head 30 presses the lettering tape 10 and is carried out by selectively heating up the lettering tape 10 up to point b where the thermal head 30 presses the lettering tape 10 at this moment. At this time, when the ink layer 59 of the lettering tape 10 and the adhesive layer 60 are selectively heated by the thermal head 30 through the base layer 58, the heated portion 68 of the ink layer 59 in the lettering tape 10 is adhered to the heated portion 69 of the adhesive layer 60 and simultaneously, the heated portion 69 of the adhesive layer 60 starts exhibiting self-adhesive properties. The above-described is a process of forming a lettering tape 10 having an integrated layered configuration including a base layer 58, an ink layer 59, a adhesive layer 60 and a release sheet 61 which are sequentially stacked, however, the lettering tape 10 itself can be converted to a lettering tape 10 enabling transfer to the target transfer body 70 simply by selectively heating, in the printer 1, the lettering tape 10 that cannot be transferred unless some action is performed to thus print or form an image. Up to here, the release sheet 61 has the role of preventing the lettering tape 10 exhibiting self-adhesive properties at the heated portion 69 of the adhesive layer 60 from adhering to and being caught in the platen roller 33, as described in the above text.

Next, at a right upper stage of FIG. 6 is shown a completed lettering tape 10 obtained by subjecting the lettering tape 19 in the state shown at the left middle stage in FIG. 6 to an operation of inserting black spaces after printing has finished, then operating the tape cutter lever 22 to cut the lettering tape 10 by cutters 71 and 71 coupled to the tape cut lever 22 provided downstream the tape cassette 26. In the completed lettering tape 10, exposure of the adhesive is prevented by coating the adhesive layer 60 with the release sheet 61, thereby eliminating the need for immediate transfer to the target transfer body to protect the tape against foreign bodies and the like. Also, the release sheet may be peeled right before transfer, thereby enabling longer storage of the tape.

Next, the right middle stage of FIG. 6 shows the state in which the release sheet 61 has been peeled off from the completed lettering tape 10 and the lettering tape 10 is adhered to the target transfer body 70. Since the heated portion 68 of the ink layer 59 is adhered to the heated portion 69 of the adhesive layer 60 only at a desired heated print portion in the ink layer 59 and the adhesive layer 60, and simultaneously, the heated portion 69 of the adhesive layer 60 exhibits self-adhesive properties, there is no need to rub the lettering tape while applying pressure from the back, as was done with the conventional lettering tape. The surface of the release sheet 61 at the side contacting the adhesive layer 60 is subjected to treatment by a stripping agent to enable smooth peeling thereof from the heated portion 69 of the adhesive layer 60 exhibiting self-adhesive properties. Although the release sheet 61 is adhered in such a way as to prevent displacement thereof at the time of running the tape even in the state that electrostatic treatment is carried out with respect to the release sheet 61 and the adhesive layer 60 exhibits no self-adhesive properties, it can be smoothly peeled off by hand after printing.

Next, at the right lower stage in FIG. 6 is shown a state in which the lettering tape 10 in the state shown in the right middle stage of FIG. 6 is peeled off. In this state, as a result of adhering the heated portion 68 of the ink layer 59 to the heated portion 69 of the adhesive layer 60 only at portions where the lettering tape 10 is selectively heated by the thermal head 30 and adhering the heated portion 69 of the adhesive layer 60 exhibiting self-adhesive properties only at portions that are selectively heated to the target transfer belt 70, when the lettering tape 10 is peeled off, only the heated portion 68 of the ink layer 59 and the heated portion 69 of the adhesive layer 60 exhibiting self-adhesive properties are transferred to the target transfer body. Thus, transferring of an image formed on the ink layer of the ink ribbon to a first transfer body (transfer sheet), and then performing a second stage transfer of transferring the image to a target second transfer body, as was done conventionally, are omitted, and the lettering tape 10 itself that cannot be transferred as is, is converted to lettering tape 10 that can be transferred through selective heating by the thermal head 30, without adding any extra components, whereby the transfer is made easy and the transfer quality is improved.

Here, in the configuration of the above-described FIG. 6, the adhesive layer 60 is protected by a release sheet 61. With the release sheet 61 is still attached, as shown in the right upper stage of FIG. 6, the printed contents cannot be identified even after the printing operation has been carried out.

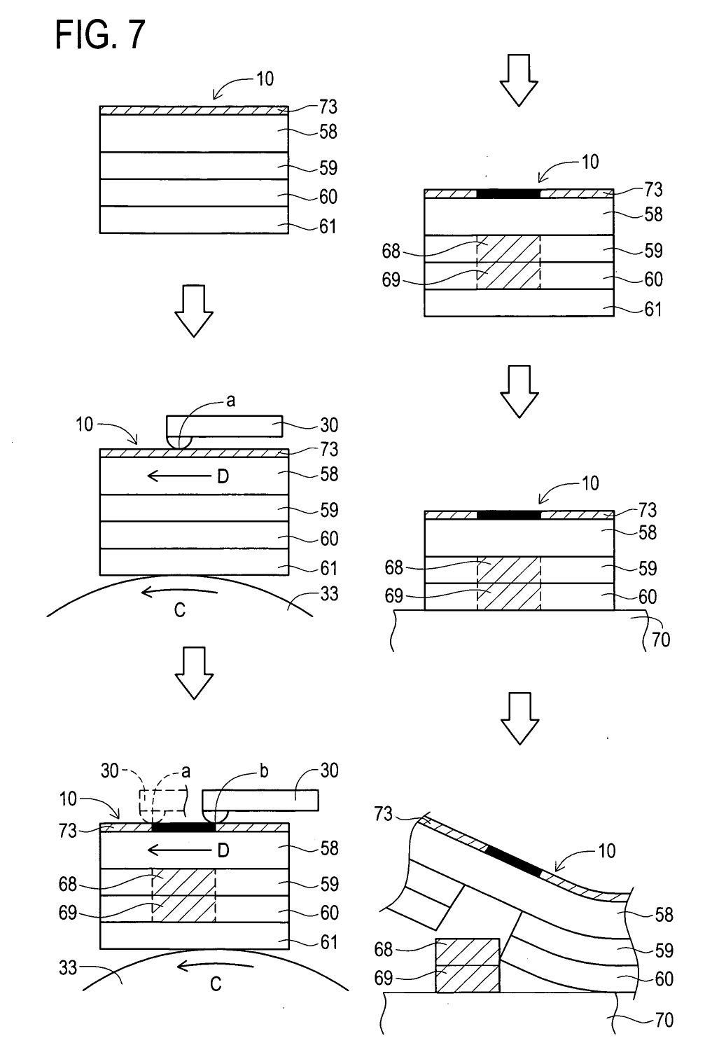

Here, as shown in FIG. 7, it is possible to adopt a configuration in which a thermo-sensitive color fixing layer 73 is coated on a surface of the base layer 58. When the thermo-sensitive color fixing layer 73 is coated as described, the thermo-sensitive color fixing layer 73 is adapted to develop a color at portions thereof which were heated by the thermal head 30, as shown in the left lower stage of FIG. 7. Since the portions where a color was developed are identical with the transferred portions, the user can identify the contents to be printed by looking at the thermo-sensitive color fixing layer 73. The thermo-sensitive color fixing layer can be caused to develop a color by simply coating a thermo-sensitive color fixing agent on the lettering tape to be printed, without adding any new processes to the transfer process shown in FIG. 6.

When the color developed in the thermo-sensitive color fixing layer 73 is set to be the same as the color of the ink layer 59, the user can identify not only the contents to be printed, but also the color to be printed.

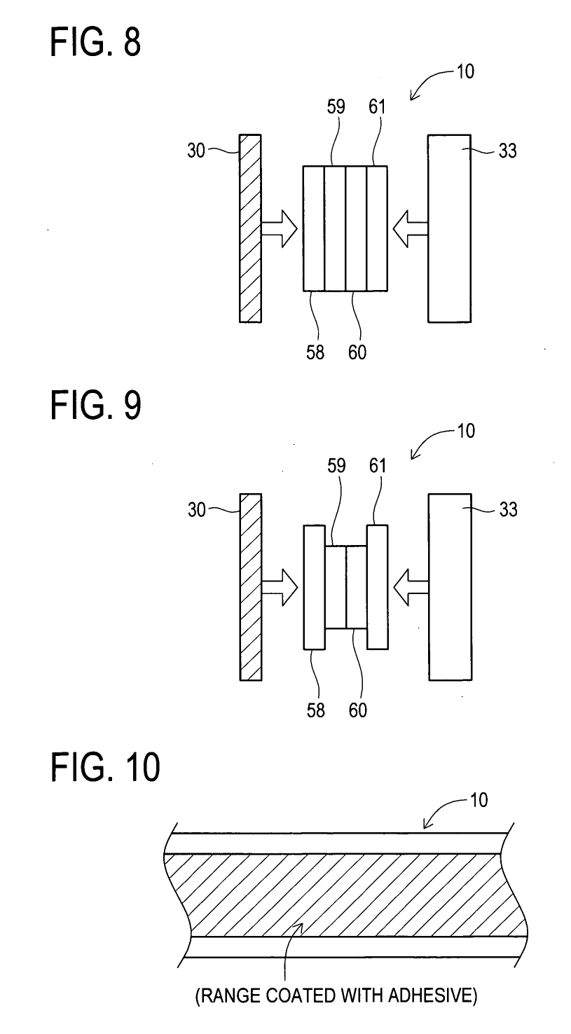

Here, if the adhesive overflows the lettering tape 10, the overflowed adhesive may adhere to the thermal head 30 or the platen roller 33. As shown in FIG. 8, if the base layer 58 and the adhesive layer 60 have the same lateral size, the adhesive of the adhesive layer 60 may overflow. Accordingly, the overflowed adhesive may adhere to the thermal head 30 or the platen roller 33.

Then, as shown in FIG. 9, the overflow of the adhesive can be prevented by making the lateral size of the adhesive layer 60 smaller than that of the base layer 58 (i.e. the lettering tape 10). FIG. 10 shows the lateral relation between the lettering tape 10 and the adhesive layer 60, indicating that the range coated with the adhesive is narrower than the area of the lettering tape 10.

Also, as shown in FIG. 9, the ink overflow can also be prevented by making the lateral size of the ink layer 59 smaller than that of the lettering tape 10. FIG. 8 shows a case where both of the adhesive layer 60 and the ink layer 59 have smaller lateral sizes. Here, it is possible to make only the lateral size of the adhesive layer 60 or only that of the ink layer 59 smaller.

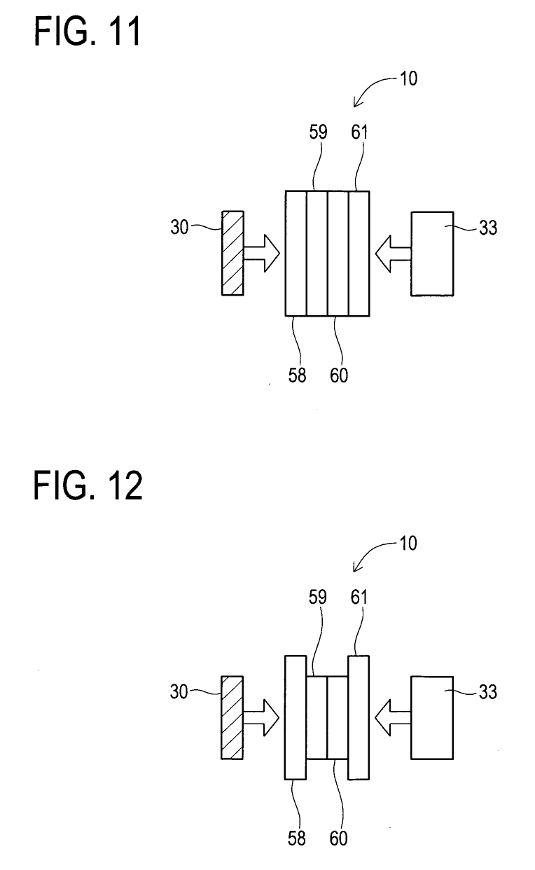

In the configuration shown in FIG. 9, the adherence of the adhesive or the ink is prevented by changing the configuration of the medium to be printed, without changing the configuration of the thermal head 30 and the platen roller 33. Here, as shown in FIG. 11, the adherence of the adhesive or the ink can be prevented by changing the configuration of the thermal head 30 and the platen roller 33.

That is, if the lateral size of the thermal head and/or that of the platen roller 33 are/is smaller than that of the lettering tape 10, the adherence of the overflowed adhesive to the thermal head 30 or the platen roller 33 can be prevented even if the ink or the adhesive overflows. Also, FIG. 11 shows the configuration wherein both the lateral size of the thermal head 30 and that of the platen roller 33 are smaller than the lateral size of the lettering tape 10 and it is possible to adopt the configuration wherein only the lateral size of the thermal head or only the platen roller 33 is made smaller.

Also, as shown in FIG. 1-2, it is possible to adopt the combined configuration of FIG. 9 and FIG. 11. In this case, the overflow of the adhesive or the ink can be prevented, and the adherence of the overflowed adhesive or ink to the platen roller 33 can be prevented even if the adhesive or the ink overflows.

As described in detail in the above text, according to the lettering tape 10 and the printer 1 in the present embodiment, a lettering tape 10 is formed comprising a base layer 58, an ink layer 59 and a adhesive layer 60 exhibiting self-adhesive properties when heated once, which are sequentially stacked into an integrated layered configuration. When this lettering tape 10 is selectively heated by the thermal head 30 to form an image, the heated portion 68 of the ink layer 59 onto which an image is formed is adhered to the heated portion 69 of the adhesive layer 60 and simultaneously, the heated portion 69 of the adhesive layer 60 exhibits self-adhesive properties, thereby converting the lettering tape 10 itself into the lettering tape 10 which enables transfer to the target transfer body 70. As a result, since a desired lettering tape can be obtained simply by heating the lettering tape 10 directly by a heat generating body, it is no longer necessary to transfer an image formed on the ink layer of a different ink ribbon to a transfer sheet, and then, carry out a second stage transfer of transferring the image to the target transfer body, thereby making handling of the lettering tape 10 easier. Also, since the second stage transfer is no longer necessary, the transfer quality can be improved.

Since the adhesive layer 60 exhibits self-adhesive properties when heated but exhibits no self-adhesive properties in a normal state when it is not heated, handling of the lettering tape 10 is made easier in terms of “preventing adherence of foreign bodies to the lettering tape 10”, “preventing accidental adherence of the lettering tape 10 to various places” and the like. Further, since the adhesive layer 60 exhibits self-adhesive properties only at the heated portions, but does not exhibit self-adhesive properties at portions that are not heated, the boundary of the portions exhibiting self-adhesive properties can be clearly determined so as to allow transfer of only portions exhibiting self-adhesive properties to the target transfer body 70.

Since the heated portion 68 of the ink layer 59 and the heated portion 69 of the adhesive layer 60 are adhered only at the desired print portions that were heated and simultaneously, the adhesive layer 60 exhibits self-adhesive properties, the heated portion 68 of the ink layer 59 can be easily transferred to the target transfer body 70 by a simple operation of peeling off the lettering tape 10 after it has been adhered to the target transfer body 70, without applying pressure and rubbing from the side of the base layer 58. As a result, any user can easily perform lettering, without any individual differences.

Also, since lateral sizes of the adhesive layer and/or the ink layer is/are smaller than the lateral size of the lettering tape, the overflow of the adhesive and/or the ink from the lettering tape can be prevented. Also, since lateral sized o the thermal head and/or the platen roller is/are smaller than the lateral size of the lettering tape, the adherence of the adhesive and/or the ink to the thermal head and/or the platen roller although the adhesive and/or the ink overflow from the lettering tape.

Since the lettering tape 10 is provided with a release sheet 61 at the side of the adhesive layer 60, the lettering tape 10 is easily handled without any adhesive being exposed at the surface of the lettering tape 10 even if the adhesive layer 60 exhibits slight self-adhesive properties. Thus, it is possible to prevent malfunctions in the printer 1 caused by the lettering tape 10 adhering to and getting caught in the platen roller 3 provided in the printer 1 and having a tape feed function, when the adhesive layer 60 exhibits self-adhesive properties when selectively heated by the thermal head 30. Since it is not necessary to consider the compatibility of the adhesive with respect to the material of the platen roller 33, the selection range of the material for the platen roller 33 can be expanded. Further, since the adhesive is not exposed, there is no need to immediately transfer the tape onto the target transfer body 70 to protect the tape against foreign bodies, and the release sheet 60 may be peeled right before transfer, thereby enabling storage of the tape as necessary.

Since the lettering tape 10 is wound into a roll tape, folding and bending, and scratching of the lettering tape 10 can be prevented from occurring when the lettering tape 10 is mounted in the printer 1. Thus, since the lettering tape 10 to be mounted is wound into roll 63, the mounting area can be minimized even in the case of mounting in the cassette case 52, and at the same time, mounting in the cassette case 52 can be made easier.

Since the tape cassette 26 houses the roll 63 of the lettering tape 10 in a cassette case 52, the tape cassette 26 (lettering tape 10) can be set to a print enable state by a simple operation of mounting the tape cassette 26 in the cassette mounting part 27 of the printer 1. It is thus possible to do without complicated operations such as routing the lettering tape 10 to bring it in a print enable state with respect to the printer 1, in the case of the lettering tape 10 only. Loading the roll 63 of the lettering tape 10 in the tape cassette 26 in advance for provision to users can prevent incorrect setting of the lettering tape 10 in the printer 1 by the user that may mistake the front and back surface of the tape.

Since in the cassette mounting part 27 of the printer 1 in which the tape cassette 26 is detachably mounted and which also comprises a thermal head 30 and a platen roller 33, the print position of the lettering tape 10 is clamped between the thermal head 30 and the platen roller 33, and simultaneously, the side of the base layer 58 in the lettering tape 10 abuts on the thermal head 30, the ink layer 59 and the adhesive layer 60 can be selectively heated without the adhesive adhering to the thermal head 30. At the same time, the use of a polyester film and the like having high heat resistance properties can improve slippage of the tape with respect to the thermal head 30 and can help reduce the load with respect to the tape conveying pulse motor 41 that drives the platen roller 33.

A printer 1 clamps a lettering tape 10 having a layered configuration in which a base layer 58, an ink layer 59 and a adhesive layer 60 exhibiting self-adhesive properties when heated once are sequentially stacked, at a print position of the lettering tape 10 by means of a thermal head 30 and a platen roller 33 provided in the cassette mounting part 27, and brings the thermal head 30 into contact with the side of the base layer 58 of the lettering tape 10 to selectively heat the ink layer 59 and the adhesive layer 60 of the lettering tape 10 through the base layer 58 by means of the thermal head, whereby the heated portion 68 of the ink layer 59 is adhered to the heated portion 69 of the adhesive layer 60 in the lettering tape 10. By causing the heated portion 69 of the adhesive layer 60 to exhibit self-adhesive properties, the lettering tape 10 can be converted to a lettering tape 10 that can be transferred to the target transfer body 70. As a result, in the printer 1, transfer of the image formed on the ink layer of a different ink ribbon to the transfer sheet followed by a second stage transfer of transferring the image to the target transfer body, as was done conventionally, are no longer required. This makes handling of the printer 1 easier and makes it possible to produce a lettering tape 10 with an improved transfer quality.

Since the adhesive layer 60 of the lettering tape 10 in printer 1 exhibits self-adhesive properties when selectively heated by the thermal head 30 but has no self-adhesive properties in a normal state when not heated, adherence of foreign bodies thereto and accidental sticking thereof to various places can be prevented, thereby making handling of the lettering tape easier. Further, since the adhesive layer 60 exhibits self-adhesive properties only at portions thereof which are selectively heated by the thermal head 30, but exhibits no self-adhesive properties at portions that are not heated, it is possible to produce a lettering tape 10 in which boundaries of portions exhibiting self-adhesive properties are clearly identified and only portions thereof which exhibit self-adhesive properties can be transferred to the target transfer body 70.

Since in the printer 1, the heated portion 68 of the ink layer 59 is adhered to the heated portion 69 of the adhesive layer 60 only at print portions thereof that are selectively heated by the thermal head 30 and simultaneously, the adhesive layer 60, from amongst the ink layer 59 and the adhesive layer 60 of the lettering tape 10, exhibits adhesive properties, it is possible to produce a lettering tape 10 in which heated portions of the ink layer can be easily transferred to the target transfer body simply by removing the lettering tape after passing to the target transfer body 70, without the need to apply pressure and rub from the side of the base layer 58.

Then, since the printer 1 is provided with cutters 71 and 71 downstream the tape discharging part 67 of the tape cassette 26 in a tape conveying direction for cutting the lettering tape 10, the post-print lettering tape 10 does not have to be cut by scissors or the like, thereby making it possible to reduce the length of the lettering tape from the print position at least one end in the longitudinal direction of the tape. This makes it possible to easily position the lettering tape 10 produced by this printer 1 at the time of transfer to the target transfer body 70.

The thermo-sensitive color fixing agent is coated on the surface contacting the thermal head, so that when the lettering tape is heated, the thermo-sensitive color fixing agent develops a color at the heated portion, thereby making it possible to identify the print contents of the lettering tape before transferring the lettering tape. As a result, transfer of wrong lettering tape can be prevented. Further, when the color that develops in the thermo-sensitive color fixing layer is set to be the same as that of the ink layer, it is possible to identify not only the contents to be printed but also the color of the ink to be printed, without removing the release sheet. As a result, transfer of wrong lettering tape can be prevented.

The disclosure is not limited to the above-described embodiment, and can be embodied in other specific forms without departing from the scope of the disclosure.

For instance, although in some embodiment, the lettering tape has a configuration comprising a release sheet layer 61, the disclosure is not limited to the above-described embodiment, and needless to say, the disclosure can also be applied to a lettering tape which does not comprise a release sheet layer. Preferably, in this case, a release agent layer is coated on the surface of the platen roller 33.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A lettering tape comprising:
a base layer;
an ink layer;
an adhesive layer exhibiting self-adhesive properties when heated;
wherein
the base layer, the ink layer, and the adhesive layer are sequentially stacked,
when the lettering tape is selectively heated by a heat generating body, a heated portion of the ink layer is adhered to a heated portion of the adhesive layer,
the heated portion of the ink layer and the heated portion of the adhesive layer are transferred to a target transfer body when the heated lettering tape is stuck to the target transfer body and then the lettering tape is removed.

2. The lettering tape according to claim 1, wherein a release sheet is provided on a side of the adhesive layer of the lettering tape.

3. The lettering tape according to claim 1, wherein the lettering tape is a winding roll tape.

4. The lettering tape according to claim 1, wherein lateral ends of the adhesive layer are located laterally inside ends of the lettering tape.

5. The lettering tape according to claim 4, wherein a lateral size of the adhesive layer is smaller than a lateral size of the lettering tape.

6. The lettering tape according to claim 4, wherein a release sheet is provided on a side of the adhesive layer of the lettering tape.

7. The lettering tape according to claim 6, wherein lateral ends of the adhesive layer are located laterally inside ends of the lettering tape.

8. The lettering tape according to claim 6, wherein a lateral size of the adhesive layer is smaller than a lateral size of the lettering tape.

9. The lettering tape according to claim 1, further comprising:
a thermo-sensitive color fixing layer;
wherein
when the lettering tape is selectively heated by a heat generating body, a heated portion of the thermo-sensitive color fixing layer develops color,
the thermo-sensitive color fixing layer is located on an opposite side of the ink layer of the base layer.

10. The lettering tape according to claim 9, wherein the developed color is the same as a color of the ink layer.

11. A tape cassette, wherein the roll tape according to claim 3 is installed.

12. The tape cassette according to claim 11,
wherein
the tape cassette is detachable in a tape printer, the tape printer including a thermal head and a platen roller,
a print position of the lettering tape is clamped between the thermal head and the platen roller when the tape cassette is mounted in the tape printer,
a side of the base layer in the lettering tape abuts on the thermal head when the tape cassette is mounted in the tape printer.

13. The tape cassette according to claim 11, wherein lateral ends of the adhesive layer are located laterally inside ends of the lettering tape.

14. The tape cassette according to claim 11, further comprising:
a thermo-sensitive color fixing layer;
wherein
when the lettering tape is selectively heated by a heat generating body, a heated portion of the thermo-sensitive color fixing layer develops color,
the thermo-sensitive color fixing layer is located on an opposite side of the ink layer of the base layer.

15. A tape printer comprising:
a cassette mounting part;
a thermal head; and
a platen roller;
wherein
a tape cassette including a lettering tape is detachable for the cassette mounting part, the lettering tape including a base layer, an ink layer, and an adhesive layer exhibiting self-adhesive properties when heated, the base layer, the ink layer, and the adhesive layer being sequentially stacked,
a side of the base layer in the lettering tape abuts on the thermal head when the tape cassette is mounted in the tape printer,
when the lettering tape is selectively heated by the thermal head, a heated portion of the ink layer is adhered to a heated portion of the adhesive layer.

16. The tape printer according to claim 15, further comprising
a cutting device; and
a tape discharging part;
wherein
the cutting device cuts the lettering tape,
the cutting device is located downstream the tape discharging part in a tape conveying direction for the lettering tape.

17. The tape printer according to claim 15, wherein lateral ends of the thermal head abuts on inside of lateral ends of the lettering tape.

18. The tape printer according to claim 17, wherein a lateral size of the thermal head is smaller than a lateral size of the lettering tape.

19. The tape printer according to claim 17,
wherein
a release sheet is provided on a side of the adhesive layer of the lettering tape,
lateral ends of the platen roller abuts on inside of lateral ends of the release sheet.

20. The tape printer according to claim 19, wherein a lateral size of the platen roller is smaller than a lateral size of the release sheet.
